(19) United States
(12) Patent Application Publication
(10) Pub. No.: US 2010/0114688 A1
(43) Pub. Date: May 6, 2010

(54) SYSTEM AND METHOD OF IMPLEMENTING A CARDLESS REWARDS PROGRAM

(75) Inventors: Dai Song, Petaling Jaya (MY); Ganesha Karuppiaya, Petaling Jaya (MY)

Correspondence Address: Workman Nydegger;1000 Eagle Gate Tower, 60 East South Temple, Salt Lake City, UT, 84111, US

(73) Assignee: CLICQUE TECHNOLOGY SDN. BHD., Petaling Jaya, Selangor Darul Ehsan (MY)

(21) Appl. No.: 12/531,804

(22) PCT Filed: Sep. 9, 2008
(86) PCT No.: PCT/MY08/00097

§ 371 Date: Nov. 10, 2009

(30) Foreign Application Priority Data
Jan. 29, 2008 (MY) PI 20080165

(51) Int. Cl. G06Q 30/00; G06Q 10/00; G06F 17/30

(52) U.S. Cl. 705/14.26; 705/14.33; 707/802; 707/769; 707/781; 707/E17.044; 707/E17.014; 707/E17.005

(57) ABSTRACT

A method and system of operating a customer rewards program that uses mobile phone networks via short messaging system as a medium of transaction of customer loyalty points between system points host, the end user and the merchant. The system also uses the mobile phone number of the end user as the loyalty card identification number.

### FIELD OF INVENTION

The present invention relates generally to methods, systems and programs for engendering loyalty in various consumers and customers, in particular, to a loyalty program using mobile phones to replace the use of loyalty cards.

### BACKGROUND OF INVENTION

In order to promote sales and encourage customer loyalty, many merchants, e.g., stores, restaurants, airlines, who sell goods or services, often implement customer loyalty programs.

Such programs are often implemented by assigning a customer a physical card, e.g., a paper card, which is then stamped by the retailer to indicate the awarding of one or more points for the purchase of a product or service. When a sufficient number of awards, e.g., loyalty points, are accumulated, in many cases the customer is allowed to redeem the accumulated points towards a product purchase, an award and/or a discount. One of the most common examples of such a customer loyalty program is a lunch card which is stamped each time a lunch is purchase and which can then be redeemed, e.g. after a fixed number of stamps, for a free lunch or discount on a lunch. In the case of lunch based loyalty programs, there is usually no centralized tracking of the number of points accumulated by individual customers. The ease with which ink stamps can be faked and the lack of any electronic accounting in such programs makes such programs the easy target for fraud.

Another example of a loyalty program involves the issuance of paper stamps, with the stamps being used to track the number of bonus points awarded. Historically, such stamps would be glued into books which would be maintained by the customers participating in the loyalty program. The stamps, stored in the books, could then be redeemed for various prizes and/or discounts. Such paper stamp based loyalty programs have fallen out of favour as people have become ever more time conscious and have come to find the collection, storage, and redemption processes associated with paper stamps used for loyalty programs both time consuming and tedious.

Another example of a customer loyalty program is frequent flyer miles. Such programs are widely used today. In the case of a frequent flyer program, an airline normally credits a bonus point for each mile of flight associated with a purchased airline ticket. Airline bonus points may also be accumulated by making purchases using a credit card associated with a particular frequent flyer program. For example, in some cases one bonus point if awarded for each dollar spent using the credit card associated with the loyalty program regardless of where an item is purchased. Airline points may expire if not used within a certain period of time.

Airline mileage bonus point programs and credit card bonus programs which provide airline mileage points rely on centralized tracking of bonus points. This reduces the risk of fraud and it allows for points to be deleted at a centralized location if the points expire. However, it also complicates bonus point award redemption procedures. Normally, to redeem the bonus points it must be done by contacting a specific representative, e.g. airline representative, with access to and control over the centralized bonus point tracking database. This makes redemption of bonus points at a wide number of retail locations impractical in many cases due to the limited access and merchant constraints with regard to accessing the bonus tracking system. From a practical standpoint, credit card companies and airlines are reluctant to give a wide variety of merchants the ability to access and directly modify bonus point information.

Given the value of bonus and loyalty programs in attracting and keeping customers, loyalty programs are of great interest to merchants. However, for such programs to gain even greater acceptance and increased levels of utilization, method of implementing such programs need to be improved.

In particular, there is a need for methods of avoiding the paper and ink stamp bonus point tracking systems which have been found to be prone to fraud and/or generally undesirable from a customer perspective due to the amount of work required to maintain and redeem the awarded loyalty points which may be in the form of paper stamps or a paper card. In order to gain widespread acceptance from the merchant perspective, there is a need to allow different merchants to award loyalty points in different amounts and/or for different items. In addition, in the case of an individual merchant owning one or more stores, it is desirable to allow the merchant flexibility in regard to the how the loyalty program is implemented at different stores and even to allow the merchant to offer different loyalty incentives at different locations within a store, e.g., at different points of sale corresponding to different departments.

In order to provide a wide degree of flexibility to a merchant, it would be desirable for a merchant to be able to update loyalty program information in multiple stores and/or to modify loyalty program information for different departments within a store from a centralized location in an automated manner.

### SUMMARY OF INVENTION

In the first aspect, the present invention provides a method of operating a rewards program including the steps of, presenting the user with at least one question, collecting at least one response to at least one question, delivering at least one response to the at least one question, delivering a number of rewards to the end user via redeemable serial numbers that are shown to the merchant.

The method of question and answer may be conducted by way of mobile phones or any other mobile communication device over GSM communication networks in particular using short messaging system (SMS).

In the second aspect, the present invention provides a method may further include steps of enabling the user to access the status of end user in rewards program via;

the user presenting at least one question to the database, presenting the user with at least one question, collecting at least one response to at least one question, delivering at least one response to the at least one question.

The method of question and answer may be conducted by way of mobile phones or any other mobile communication device over GSM communication networks in particular using short messaging system.

### DESCRIPTIONS OF DRAWINGS

FIG. 1 represents a block diagram of the overall invention

FIG. 2 represents a service flow of the rewards system

FIG. 3 represents the redemption flow of the customer.

FIG. 4 represents the types of user groups available in the rewards system.

### DETAILED DESCRIPTION OF PREFERRED EMBODIMENT

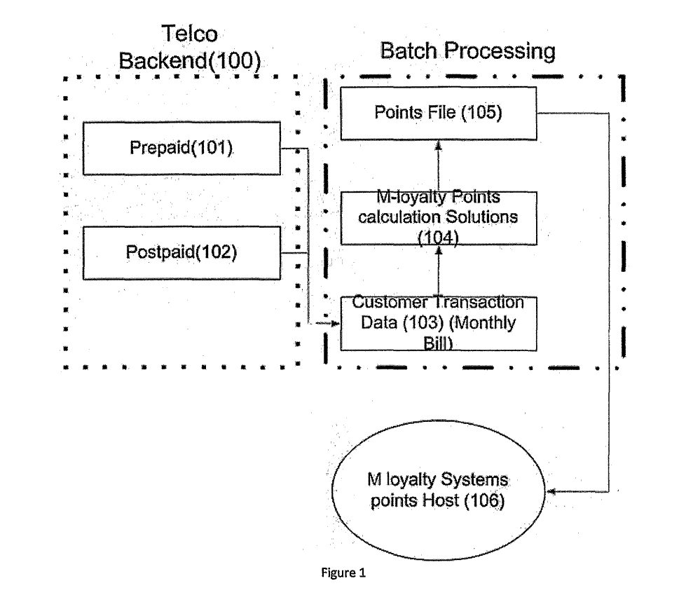

FIG. 1 is a block diagram of the system according to the invention. Customers are defined as end user of the mobile services network provider and the rewards points/loyalty points system. Merchants are defined as vendors in the rewards program that the customer redeem but not limited to their points for goods, services and discounts.

The Telco backend (100) comprises of the mobile services network provider. The prepaid (101) and the post-paid (102) are the billing solutions offered to all the customers of the mobile services network provider. The rewards points/loyalty points are recorded in the monthly customer transaction (103) statement given by the mobile services network provider to the mobile services network provider customers.

The rewards points/loyalty points are recorded in the monthly statement are extracted periodically by the Points calculation solution software (104). The point calculation solution software (104) is middleware that extracts raw data from the monthly customer transaction (103) statement and calculates the rewards points/loyalty points accumulated and used by the customer.

The point calculation solution software (104) categorizes the rewards points/loyalty points accumulated and used by the customer to individual customer accounts and Points File (105) to the System points Host Database (106). This is a process of categorizing the user data on the System points Host Database (106) for record keeping as well as for extraction at any time the customer requests a status on the rewards/loyalty point's i.e the balance of the reward/loyalty points available.

The System points Host Database (106) is a memory system that contains all the customer information but not limited to rewards/loyalty points earned, rewards/loyalty points redeemed, customer information i.e name, mobile phone number, personal particulars of customers. All customers are identified using mobile phone numbers i.e the serial of the customer in the rewards program is the customer mobile phone number which is unique to each customer. This mobile phone number is also used as a reference for billing in the monthly customer transaction (103) statement.

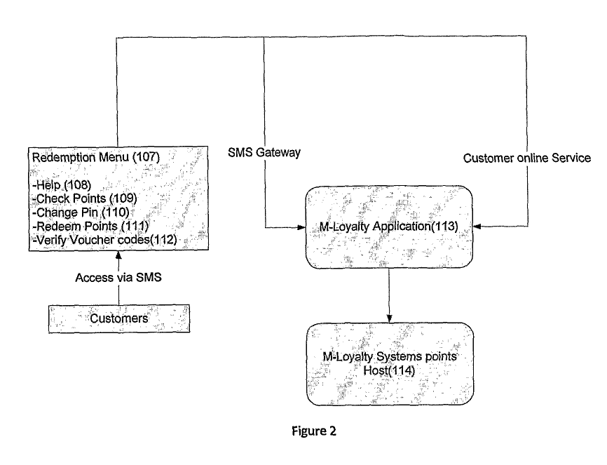

FIG. 2 is a service flowchart of the system according to the invention. The customer accesses the redemption menu (107) by typing a certain code and sending it to a loyalty application (113) to access the Loyalty system point Database (114) via mobile services network provider using a short message service gateway. The number that the short message is sent to is a number assigned buy the mobile service provider that is not less than 3 numbers. The redemption menu is divided into at least 5 main menus. The customer types <HELP> in a short message service and sends that short message to the loyalty application (113) in order to access the Loyalty system point Database (114) via mobile services network provider using a short message service gateway. The loyalty application (113) then responds via mobile services network provider using a short message service gateway and provides a set of instructions on how the customer should use the system.

The customer types <Chkpts> in a short message service and sends that short message to the loyalty application (113) to access the Loyalty system point Database (114) via mobile services network provider using a short message service gateway. The loyalty application (113) then responds via mobile services network provider using a short message service gateway and provides a answer after retrieving the relevant information of amount of remaining rewards/loyalty points available to the customer from the Loyalty system point Database (114).

The customer types <Chgpin> <space><pin number> in a short message service and sends that short message to the loyalty application (113) to access the Loyalty system point Database (114) via mobile services network provider using a short message service gateway. The customer then types <new-pin number> in a short message service and sends that short message to the loyalty application (113) to access the Loyalty system point Database (114) via mobile services network provider using a short message service gateway. The new pin number of the customer is stored in the Loyalty system point Database (114).

The customer types <Redeem> <space><pin number> in a short message service and sends that short message to the loyalty application (113) to access the Loyalty system point Database (114) via mobile services network provider using a short message service gateway. The customer then types <gift-code> in a short message service and sends that short message to the loyalty application (113) to access the Loyalty system point Database (114) via mobile services network provider using a short message service gateway. The gift code is obtained by the customer form a catalogue or from the worldwide web where there is a list of items that can be redeemed using loyalty/rewards points and the names and locations of vendors that the items can be redeemed. The loyalty application (113) then responds via mobile services network provider using a short message service gateway with a request for confirmation on the redemption request. The customer then replies yes or no in a short message service and sends that short message to the loyalty application (113) to access the Loyalty system point Database (114) via mobile services network provider using a short message service gateway. The loyalty application (113) then responds via mobile services network provider using a short message service gateway with a voucher code that is to be presented to the vendor.

The customer presents the voucher code to the vendor and claims the item or service from the vendor. The vendor then types <SUP> <space><supplier-ID> in a short message service and sends that short message to the loyalty application (113) to access the Loyalty system point Database (114) via mobile services network provider using a short message service gateway.

The vendor then types <voucher code> that is presented by the customer in a short message service and sends that short message to the loyalty application (113) to access the Loyalty system point Database (114) via mobile services network provider using a short message service gateway. The loyalty application (113) then responds via mobile services network provider using a short message service gateway with a request for confirmation on the redemption request. The vendor then replies yes or no in a short message service and sends that short message to the loyalty application (113) to access the Loyalty system point Database (114) via mobile services network provider using a short message service gateway.

The vendor then provides the redemption item to the customer.

The loyalty application (113) access the Loyalty system point Database (114) and deducts the loyalty/rewards points form the customer account. The loyalty application (113) then generates a payment report that is given to the mobile services network provider and the vendor.

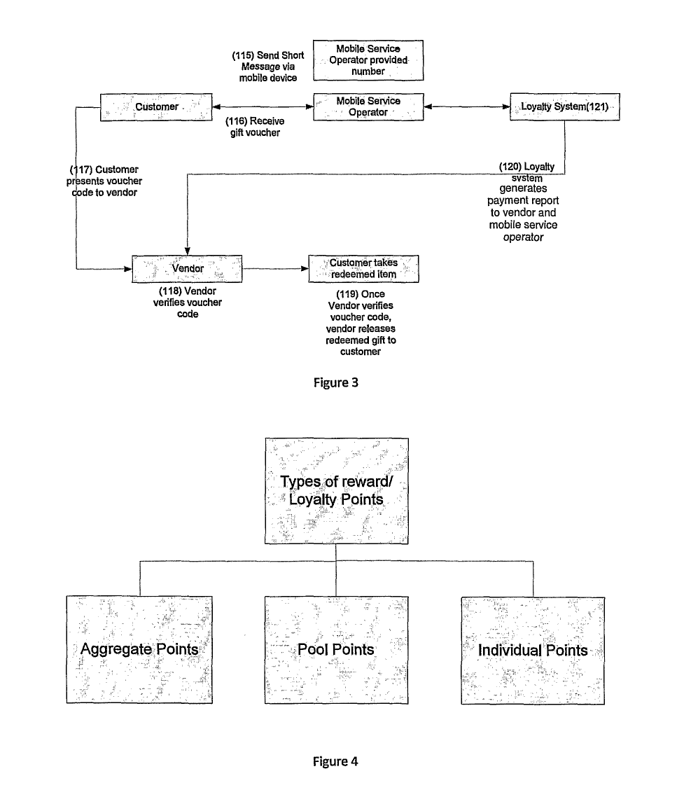

FIG. 3 is the customer redemption flowchart according to the invention. The customer sends a short message (115) via the mobile operator network accessing the Loyalty system (121) which is encompasses the application (113) access the Loyalty system point Database (114). The short message contains the customer pin number. The customer then sends another short message (115) to the Loyalty system, the short message contains the gift code that the customer wants to redeem from the vendor. The Loyalty system (121) then replies with a voucher code (116) to the customer. The customer then presents this voucher code to the vendor (117). The vendor then verifies the voucher code via short message to the loyalty system (118). The loyalty system then provides verification on the authenticity of the voucher code and the vendor releases the redeemed gift to the customer (119). The loyalty system then generates a loyalty system generates payment report to vendor and mobile service operator (120) for records.

The customer can also access the loyalty application (113) via phone call to the Customer Service agent via an online customer service. The online customer service has direct access to the Loyalty Application and can clarify customer queries, and make manual changes to the Loyalty system points database should there be systems errors.

FIG. 4 is the customer rewards/loyalty point classification according to the invention. The aggregate points are a group of customers collecting rewards points according to the invention under one account. An aggregate group is defined as a group of customers which have no association with each other.

The pool points are a group of customers collecting rewards points according to the invention under one account. A pool group is defined as a group of customers which have an association with each other such as members of a family, employees of a company etc.

The individual points are single customers collecting rewards points according to the invention under one account. An individual is defined as a single customer.

The loyalty application (113) is able to transfer points between aggregate groups, pool groups and individuals within the same loyalty system points host (114), Further to this, the loyalty application (113) is able to transfer rewards/loyalty points to and from other rewards programs using mobile network service providers or other communication means through the loyalty application (113).

The loyalty application also has the means to delete rewards/loyalty points from the loyalty system points host (114) via the loyalty application (113). This can be done based on customer request, correction of rewards/loyalty points wrongly awarded by the system, rewards/loyalty points transfer or due to expiry of point based on time.

1. (canceled)

2. (canceled)

3. A system for operating a rewards program with a mobile communication device including:
a) a presentation device for a user to make a request for information related to the rewards program;
b) a collection device for the user to receive the requested information; and
c) a delivery mechanism for delivering one of a number of voucher codes associated with one or more rewards to the user,
wherein the system is configured to select a particular voucher code associated with a particular reward for delivery to the user based on at least some of the information requested from the user.

4. A system according to claim 3 wherein either of the collection device or the presentation device are connected to a remote access-able software application by way of the mobile communication network, wherein the mobile communication network is one of GSM and PCN networks.

5. A system according to claim 3 further including a database for storing user information including personal information and rewards/loyalty points balance.

6. A system according to claim 3 further including means for viewing reports based on the information related to the rewards program.

7. (canceled)

8. A system according to claim 3, wherein mobile phone numbers are used as loyalty/rewards points account numbers.

9-12. (canceled)

13. A method for a rewards program to provide access to an end user to reward gifts over a mobile communications network without the need for a separate rewards card or other reward device, the method comprising:
an act of receiving a personal identification value from a remote mobile computing device over the mobile communications network, the personal identification value configured to identify a user of the remote mobile computing device;
an act of accessing a reward account associated with the user of the remote mobile computing device, the reward account including one or more reward points that are configured to be redeemed for one or more rewards, the reward account included within a database stored on a physical memory;
an act of receiving a request from the remote mobile computing device to obtain a specified reward based on a predetermined amount of reward points;
an act of determining if the reward account includes enough reward points for the specified reward; and
an act of providing a voucher code to the remote mobile computing device corresponding to the specified reward, wherein the voucher code is configured to be presented to a specified vendor to receive the specified reward.

14. The method in accordance with claim 13, further comprising:
an act of deducting the predetermined amount of reward points from the reward account.

15. The method in accordance with claim 13, further including:
an act of generating a payment report; and
an act of providing the payment report to the specified vendor and to an operator of the mobile communications network.

16. The method in accordance with claim 13, wherein the remote mobile computing device is one of a mobile phone, a personal digital assistant, or a handheld mobile computer.

17. The method in accordance with claim 13, wherein a mobile phone number is used as an account number for the reward account.

18. The method in accordance with claim 13, wherein the reward points are sub-divided into one or more user groups and individual groups and wherein a user group need not have any ties or connection to another user group.

19. The method in accordance with claim 18, wherein the rewards points may be transferred from one user group to another user group or individual group or from one individual user group to another user group or individual user group.

20. The method in accordance with claim 13, wherein the database further includes information related to the user of the remote mobile computing device.

21. A method for a rewards program to allow a vendor to verify that a rewards voucher is authentic over a mobile communications network without the need for the vendor to issue a separate rewards card, the method comprising:
an act of receiving a request from a remote mobile computing device of a vendor to verify that a voucher code that is received by the vendor from a customer is authentic, wherein the voucher code specifies a gift reward that is to be given to a customer of the vendor based on a predetermined amount of reward points, wherein the vendor specifies the gift reward that associated with the voucher code;
an act of accessing a database stored on a physical computer memory, the database including voucher code verification information;
an act of verifying that the voucher code associated with the request to verify is authentic based on the voucher code verification information; and
in response to determining that the voucher code is authentic, an act of providing to the remote mobile computing device of the vendor verification that the voucher code is authentic, wherein the vendor is authorized to provide the gift reward associated with the voucher code to the customer.

22. The method in accordance with claim 21, further comprising:
an act of generating a payment report; and
an act of providing the payment report to the vendor and to an operator of the mobile communications network.

23. The method in accordance with claim 21, wherein the remote mobile computing device is one of a mobile phone, a personal digital assistant, or a handheld mobile computer.

24. The method in accordance with claim 21, wherein the database further includes account information related to the customer.

25. The method in accordance with claim 21, further comprising prior to providing verification that the voucher code is authentic:
act of generating a confirmation request configured to determine if the vendor wishes to participate in the rewards program; and
an act of sending the confirmation request to the remote mobile computing device of the vendor.

26. The method in accordance with claim 25, further comprising:
an act of receiving from the remote mobile computing device of the vendor acknowledgement that the vendor wishes to participate in the rewards program.

27. The method in accordance with claim 21, wherein the mobile communication network is one of a GSM and PCN network.
